(19) United States
(12) Patent Application Publication
(10) Pub. No.: US 2026/0100653 A1
(43) Pub. Date: Apr. 9, 2026

(54) POWER CONVERSION DEVICE AND CONTROL METHOD THEREOF

(71) Applicant: LITE-ON Technology Corporation, Taipei City (TW)

(72) Inventor: Zhong-Heng Li, Taipei City (TW)

(21) Appl. No.: 19/058,011

(22) Filed: Feb. 20, 2025

(30) Foreign Application Priority Data
Oct. 8, 2024 (CN) 2024113913789

(51) Int. Cl. H02M 3/335; H02M 1/00; H02M 1/14; H02M 1/42; H02M 3/00

(52) U.S. Cl. CPC H02M 3/33573; H02M 1/0016; H02M 1/14; H02M 1/42; H02M 3/01

(57) ABSTRACT

A power conversion device and a control method thereof are disclosed. The power conversion device includes a power factor correction circuit, an LLC converter coupled to the power factor correction circuit, and a controller coupled to the power factor correction circuit and the LLC converter. The power factor correction circuit outputs a direct-current voltage and a ripple voltage associated with the direct-current voltage, the LLC converter receives the direct-current voltage and outputs an output current, and the controller receives the ripple voltage and generates a plurality of switch control signals to the LLC converter, wherein the controller compensates the output current according to the ripple voltage to adjust the plurality of switch control signals.

### BACKGROUND

### 1. Technical Field

The present application relates to the field of power conversion and, more particularly, to a power conversion device and a control method thereof.

### 2. Description of the Related Art

The power conversion device mainly consists of a front-end power factor correction (PFC) circuit, a rear-end LLC converter, and a controller, which are mutually coupled. However, the direct-current voltage output by the front-end power factor correction circuit contains ripple voltage, which makes it difficult for the rear-end LLC converter to receive and use the direct-current voltage as the input voltage, as it is easily affected by the ripple voltage. This results in ripple current in the output current, which affects the control accuracy of the controller and, in turn, the stability of the output of the LLC converter.

Therefore, there is a need to provide a better solution to address the shortcomings of the prior art.

### SUMMARY

In view of the shortcomings of the prior art, the main purpose of the present application is to provide a power conversion device and a control method thereof that utilizes ripple voltage for compensation to enhance the control accuracy of the controller and the stability of the output of the LLC converter.

To solve the shortcomings of the prior art, the power conversion device of the present application includes:
a power factor correction circuit configured to output a direct-current voltage and a ripple voltage associated with the direct-current voltage;
an LLC converter coupled to the power factor correction circuit for receiving the direct-current voltage and outputting an output current; and
a controller coupled to the power factor correction circuit and the LLC converter and receiving the ripple voltage, the controller configured to generate a plurality of switch control signals for the LLC converter according to the ripple voltage and the output current; wherein the controller compensates the output current according to the ripple voltage to adjust the switch control signals.

Preferably, the power conversion device further includes a current sensing circuit coupled to the LLC converter and the controller, sensing the output current and sending the sensed output current to the controller.

Preferably, the controller further includes:
a first subtraction circuit configured to calculate a current difference between the output current and a target current;
a first control circuit coupled to the first subtraction circuit and configured to generate a first adjustment parameter according to the current difference;
a first gain circuit configured to generate a second adjustment parameter according to the ripple voltage;
a second subtraction circuit coupled to the first control circuit and the first gain circuit and configured to subtract the second adjustment parameter from the first adjustment parameter and generate a third adjustment parameter;
a second gain circuit coupled to the second subtraction circuit and configured to generate a switching frequency parameter according to the third adjustment parameter; and
a pulse signal generator circuit coupled to the second gain circuit and the LLC converter and configured to generate the plurality of switch control signals for the LLC converter according to the switching frequency parameter.

Preferably, the controller is further configured to adjust a gain value of the first gain circuit according to the switching frequency parameter, and the first gain circuit multiplies a next ripple voltage by the adjusted gain value to generate a next second adjustment parameter.

Preferably, when the controller determines that the switching frequency parameter is less than a resonant frequency, the controller adjusts the gain value of the first gain circuit to a first gain value; and
when the controller determines that the switching frequency parameter is equal to or greater than the resonant frequency, the controller adjusts the gain value of the first gain circuit to a second gain value;
wherein the first gain value is greater than the second gain value.

Preferably, the controller further includes:
a first low-pass filter circuit coupled to the first subtraction circuit and the first control circuit; and
a second low-pass filter circuit coupled to the power factor correction circuit and the first gain circuit.

Preferably, the LLC converter includes:
a switching circuit coupled to the controller for receiving the direct-current voltage and the plurality of switch control signals;
a resonant circuit coupled to the switching circuit;
a transformer having a first side and a second side, the first side of the transformer is coupled to the resonant circuit; and
a rectifier circuit coupled to the second side of the transformer to output the output current.

The present application achieves the above-described object through the aforementioned structure, in which the controller receives the ripple voltage from the power factor correction circuit and the output current from the LLC converter and compensates the output current according to the ripple voltage to adjust the plurality of switch control signals for the LLC converter. This reduces ripple current in the output current of the LLC converter and improves the control accuracy of the controller and the stability of the output of the LLC converter.

To solve the drawbacks of the existing technology, the other technical aspect of the present application is a control method for a power conversion device, wherein the power conversion device includes a power factor correction circuit, an LLC converter and a controller, the LLC converter is coupled to the power factor correction circuit, and the controller is coupled to the power factor correction circuit and the LLC converter; the power factor correction circuit outputs a direct-current voltage and a ripple voltage associated with the direct-current voltage, the LLC converter receives the direct-current voltage and outputs an output current, the controller receives the ripple voltage from the power factor correction circuit, the control method including the following steps:
the controller generating a plurality of switch control signals for the LLC converter according to the ripple voltage and the output current; and
the controller compensating the output current according to the ripple voltage to adjust the plurality of switch control signals.

Preferably, the controller further includes a first subtraction circuit, a first control circuit, a first gain circuit, a second subtraction circuit, a second gain circuit, and a pulse signal generator circuit, the first control circuit is coupled to the first subtraction circuit, the second subtraction circuit is coupled to the first control circuit and the first gain circuit, the second gain circuit is coupled to the second subtraction circuit, and the pulse signal generator circuit is coupled to the second gain circuit and the LLC converter. The control method further includes the following steps:
the first subtraction circuit calculating a current difference between the output current and a target current;
the first control circuit generating a first adjustment parameter according to the current difference;
the first gain circuit generating a second adjustment parameter according to the ripple voltage;
the second subtraction circuit subtracting the second adjustment parameter from the first adjustment parameter to generate a third adjustment parameter;
the second gain circuit generating a switching frequency parameter according to the third adjustment parameter; and
the pulse signal generator circuit generating the plurality of switch control signals for the LLC converter according to the switching frequency parameter.

Preferably, the control method further includes the following steps: the controller adjusting the gain value of the first gain circuit according to the switching frequency parameter; and
the first gain circuit multiplying a next ripple voltage by the adjusted gain value to generate a next second adjustment parameter.

Preferably, the control method further includes the following steps:
when the controller determines that the switching frequency parameter is less than a resonant frequency, adjusting the gain value of the first gain circuit to a first gain value; and
when the controller determines that the switching frequency parameter is equal to or greater than the resonant frequency, adjusting the gain value of the first gain circuit to a second gain value;
wherein the first gain value is greater than the second gain value.

According to the steps described above, the controller compensates the output current from the LLC converter according to the ripple voltage from the power factor correction circuit and adjusts the plurality of switch control signals for the LLC converter, achieving the purpose of improving the control accuracy of the controller and the stability of the output of the LLC converter.

### BRIEF DESCRIPTION OF THE DRAWINGS

The accompanying drawings presented herein serve to deepen the understanding of the present application and are an integral part thereof. The illustrative embodiments and their explanations are provided to elucidate the present application and do not impose any undue limitations on it. In the drawings:

FIG. 1 is a schematic diagram of an embodiment of the power conversion device of the present application;

FIG. 2 is a schematic diagram of an embodiment of the LLC converter of the present application;

FIG. 3 is a schematic diagram of an embodiment of the controller of the present application;

FIG. 4 is a schematic diagram of another embodiment of the controller of the present application;

FIG. 5 is a flowchart of an embodiment of the control method of the present application.

### DETAILED DESCRIPTION OF THE EMBODIMENTS

Below, in conjunction with the drawings of the embodiments of the present application, the technical solutions of the embodiments will be clearly and completely described. It is evident that the described embodiments are a portion of the present application's embodiments, not all of them. Based on the disclosed embodiments, any other embodiments obtained by those skilled in the art without creative efforts shall fall within the scope of protection of the present application.

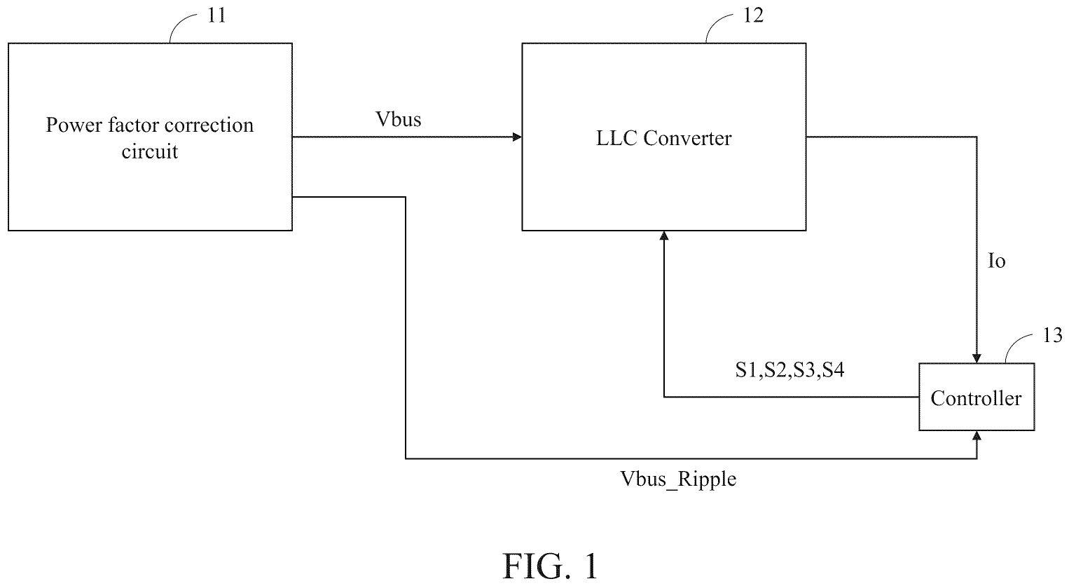

Please refer to FIG. 1. An embodiment of the power conversion device of the present application includes a power factor correction circuit 11, an LLC converter 12, and a controller 13. The LLC converter 12 is coupled to the power factor correction circuit 11. The controller 13 is coupled to the power factor correction circuit 11 and the LLC converter 12. The power factor correction circuit 11 outputs a direct-current voltage Vbus and a ripple voltage Vbus_Ripple associated with the direct-current voltage Vbus. The LLC converter 12 receives the direct-current voltage Vbus from the power factor correction circuit 11 and outputs an output current Io. The controller 13 receives the ripple voltage Vbus_Ripple and the output current Io. The controller 13 is configured to generate a plurality of switch control signals S1, S2, S3, and S4 for the LLC converter 12 according to the ripple voltage Vbus_Ripple and the output current Io, wherein the controller 13 compensates the output current Io according to the ripple voltage Vbus_Ripple to adjust the plurality of switch control signals S1, S2, S3, and S4. In the present embodiment, the power factor correction circuit 11 can sample the ripple voltage Vbus_Ripple from the direct-current voltage Vbus through a sampling circuit (not shown in FIG. 1) and output the ripple voltage Vbus_Ripple to the controller 13.

Thus, by having the controller 13 receive the ripple voltage Vbus_Ripple from the power factor correction circuit 11 and the output current Io from the LLC converter 12 and compensating the output current Io according to the ripple voltage Vbus_Ripple to adjust the plurality of switch control signals S1, S2, S3, and S4, the output current Io output by the LLC converter 12 may have a reduced ripple current, thus improving the control accuracy of the controller and the stability of the output of the LLC converter.

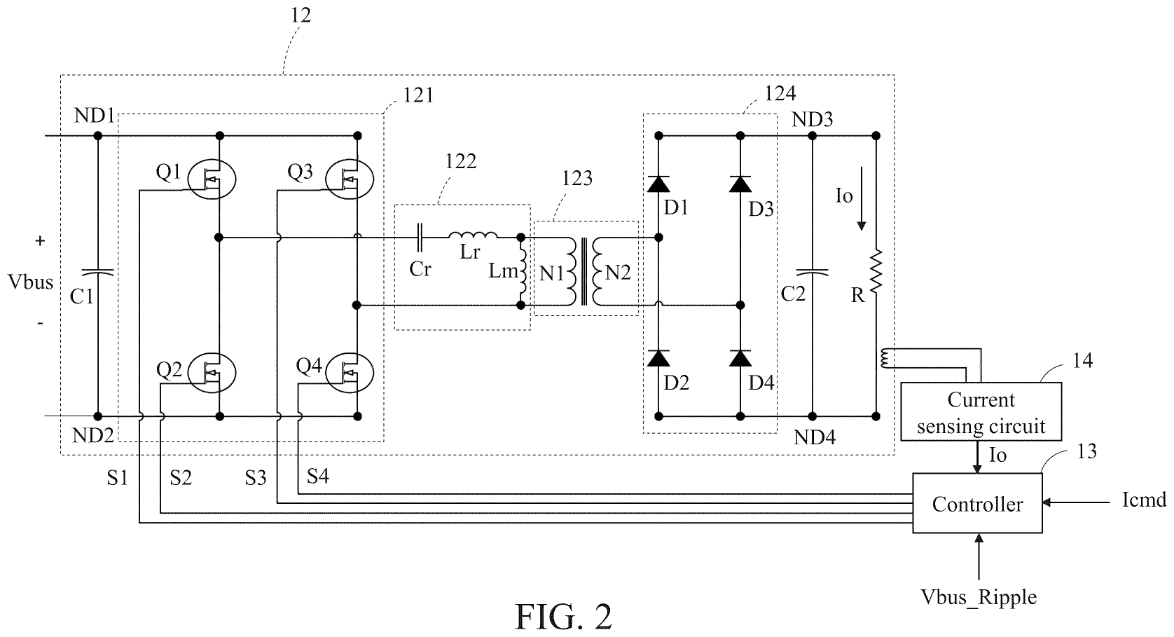

Please refer to FIG. 2. In the present embodiment, the LLC converter 12 includes a switching circuit 121, a resonant circuit 122, a transformer 123, and a rectifier circuit 124. The switching circuit 121 is coupled to the controller 13 and receives the direct-current voltage Vbus and the plurality of switch control signals S1, S2, S3, and S4. The resonant circuit 122 is coupled to the switching circuit 121. The transformer 123 has a first side and a second side, with the first side of the transformer 123 being coupled to the resonant circuit 122. The rectifier circuit 124 is coupled to the second side of the transformer 123 and outputs the output current Io.

In the present embodiment, the switching circuit 121 includes a first switch Q1, a second switch Q2, a third switch Q3, and a fourth switch Q4. A first terminal of the first switch Q1 is coupled to a first terminal of the third switch Q3, and a second terminal of the first switch Q1 is coupled to a first terminal of the second switch Q2. A second terminal of the third switch Q3 is coupled to a first terminal of the fourth switch Q4, and a second terminal of the fourth switch Q4 is coupled to a second terminal of the second switch Q2. The third terminals of the first switch Q1, the second switch Q2, the third switch Q3, and the fourth switch Q4 are respectively coupled to the controller 13. In the present embodiment, the first switch Q1, the second switch Q2, the third switch Q3, and the fourth switch Q4 respectively receive the plurality of switch control signals S1, S2, S3, and S4 from the controller 13 to drive the first switch Q1, the second switch Q2, the third switch Q3, and the fourth switch Q4.

As shown in FIG. 2, in the present embodiment, the LLC converter 12 further includes a first capacitor C1. A first terminal of the first capacitor C1 is coupled to the first terminal of the first switch Q1 and the first terminal of the third switch Q3 to form a first connection node ND1. A second terminal of the first capacitor C1 is coupled to the second terminal of the second switch Q2 and the second terminal of the fourth switch Q4 to form a second connection node ND2. In the present embodiment, the first connection node ND1 and the second connection node ND2 receive the direct-current voltage Vbus from the power factor correction circuit 11.

In the present embodiment, the resonant circuit 122 includes a resonant capacitor Cr, a first inductor Lr, and a second inductor Lm. A first terminal of the resonant capacitor Cr is coupled to the second terminal of the first switch Q1 and the first terminal of the second switch Q2. A second terminal of the resonant capacitor Cr is coupled to a first terminal of the first inductor Lr. A second terminal of the first inductor Lr is coupled to a first terminal of the second inductor Lm. A second terminal of the second inductor Lm is coupled to the second terminal of the third switch Q3 and the first terminal of the fourth switch Q4.

In the present embodiment, the transformer 123 includes a first winding N1 and a second winding N2. A first terminal of the first winding N1 is coupled to a first terminal of the second inductor Lm, and a second terminal of the first winding N1 is coupled to a second terminal of the second inductor Lm so as to form the first side of the transformer 123. The second winding N2 is coupled to the rectifier circuit 124 to form the second side of the transformer 123. In the present embodiment, the resonant circuit 122 generates a current loop according to the plurality of switch control signals S1, S2, S3, and S4 at the first side of the transformer 123, thus causing the transfer of electrical energy between the first and second sides of the transformer 123.

As shown in FIG. 2, in the present embodiment, the rectifier circuit 124 outputs the current flowing through the second side of the transformer 123 to output the output current Io. The rectifier circuit 124 includes a first diode D1, a second diode D2, a third diode D3, and a fourth diode D4. A first terminal of the first diode D1 is coupled to a second terminal of the second diode D2 and a first terminal of the second winding N2. A first terminal of the third diode D3 is coupled to a second terminal of the fourth diode D4 and a second terminal of the second winding N2. A second terminal of the first diode D1 is coupled to a second terminal of the third diode D3 to form a third connection node ND3, and a first terminal of the second diode D2 is coupled to a first terminal of the fourth diode D4 to form a fourth connection node ND4. In another embodiment, the first diode D1, the second diode D2, the third diode D3, and the fourth diode D4 may be replaced with switches or transistors. In this embodiment, the rectifier circuit 124 is coupled to the controller 13, and the controller 13 is further configured to generate switch control signals for switches of the rectifier circuit 124.

In the present embodiment, the LLC converter 12 further includes a second capacitor C2 and a load R. The second capacitor C2 and the load R have their first terminals coupled to the third connection node ND3 and their second terminals coupled to the fourth connection node ND4. In the present embodiment, the output current Io flows through the load R. Additionally, the rectifier circuit 124 outputs an output voltage to the load R. The load R can be a resistor.

In the present embodiment, the power conversion device of the present application further includes a current sensing circuit 14, which is coupled to the load R and the controller 13, as shown in FIG. 2. The current sensing circuit 14 is configured to sense the output current Io flowing through the load R and send the sensed output current Io to the controller 13. The controller 13 detects and receives the output current Io flowing through the load R through the current sensing circuit 14.

Furthermore, in the present embodiment, the controller 13 can further receive a target current Icmd. For example, this can be done through a digital signal processor (DSP) or a microcontroller for calculating and setting the target current Icmd and providing the target current Icmd to the controller 13.

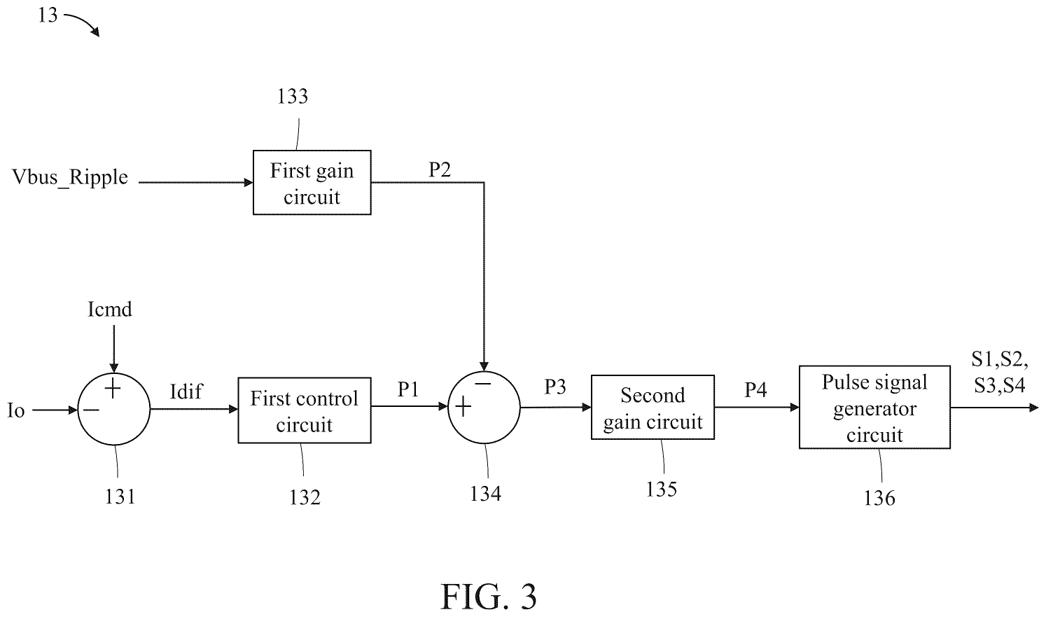

For a more specific explanation of the compensation method of the controller 13, please refer to FIG. 3. In the present embodiment, the controller 13 further includes a first subtraction circuit 131, a first control circuit 132, a first gain circuit 133, a second subtraction circuit 134, a second gain circuit 135 and a pulse signal generator circuit 136. The first subtraction circuit 131 may be coupled to the LLC converter 12, the first control circuit 132 is coupled to the first subtraction circuit 131, the first gain circuit 133 may be coupled to the power factor correction circuit 11, the second subtraction circuit 134 is coupled to the first control circuit 132 and the first gain circuit 133, the second gain circuit 135 is coupled to the second subtraction circuit 134, and the pulse signal generator circuit 136 is coupled to the second gain circuit 135 and the first switch Q1, the second switch Q2, the third switch Q3 and the fourth switch Q4 of the switching circuit 121 of the LLC converter 12.

In the present embodiment, the first subtraction circuit 131 receives the output current Io and the target current Icmd, and the first subtraction circuit 131 is configured to calculate a current difference Idif between the output current Io and the target current Icmd. The first subtraction circuit 131 can subtract the output current Io from the target current Icmd to generate the current difference Idif, and the first subtraction circuit 131 provides the current difference Idif to the first control circuit 132.

In the present embodiment, the first control circuit 132 is configured to generate a first adjustment parameter P1 according to the current difference Idif, and the first control circuit 132 provides the first adjustment parameter P1 to the second subtraction circuit 134. For example, the first control circuit 132 can be composed of a proportional-integral-differential (PID) control circuit.

In the present embodiment, the first gain circuit 133 receives the ripple voltage Vbus_Ripple, and the first gain circuit 133 is configured to generate a second adjustment parameter P2 according to the ripple voltage Vbus_Ripple. The first gain circuit 133 can multiply the ripple voltage Vbus_Ripple by a gain value to generate the second adjustment parameter P2, and the first gain circuit 133 provides the second adjustment parameter P2 to the second subtraction circuit 134.

As shown in FIG. 3, in the present embodiment, the second subtraction circuit 134 is configured to subtract the second adjustment parameter P1 from the first adjustment parameter P2 to compensate, thereby generating a third adjustment parameter P3. The second subtraction circuit 134 provides the third adjustment parameter P3 to the second gain circuit 135.

In the present embodiment, the second gain circuit 135 is configured to generate a switching frequency parameter P4 according to the third adjustment parameter P3 for the pulse signal generator circuit 136. The switching frequency parameter P4 corresponds to the switching frequencies of the plurality of switch control signals S1, S2, S3, and S4.

In the present embodiment, the pulse signal generator circuit 136 is configured to generate the plurality of switch control signals S1, S2, S3, and S4 according to the switching frequency parameter P4 for the first switch Q1, the second switch Q2, the third switch Q3, and the fourth switch Q4 of the LLC converter 12.

Through the aforementioned manner, the controller 13 can compensate the output current Io according to the ripple voltage Vbus_Ripple, thereby adjusting the switching frequencies of the plurality of switch control signals S1, S2, S3, and S4 such that the plurality of switch control signals S1, S2, S3, and S4 can instantaneously change in response to the change in the ripple voltage Vbus_Ripple, thereby reducing the ripple current in the output current Io of the LLC converter 12.

To avoid the problem of over-compensation or under-compensation, the controller 13 can further configured to adjust the gain value of the first gain circuit 33 according to the switching frequency parameter P4 in the present embodiment such that the first gain circuit 133 multiplies the next ripple voltage Vbus_Ripple by the adjusted gain value to generate a next second adjustment parameter P2.

In the present embodiment, when the controller 13 determines that the switching frequency parameter P4 is less than a resonant frequency, the controller 13 adjusts the gain value of the first gain circuit 133 to a first gain value. When the controller 13 determines that the switching frequency parameter P4 is equal to or greater than the resonant frequency, the controller 13 adjusts the gain value of the first gain circuit 133 to a second gain value, wherein the first gain value is greater than the second gain value. The switching frequency parameter P4 corresponds to the switching frequencies of the plurality of switch control signals S1, S2, S3, and S4. When the switching frequency parameter P4 is less than the resonant frequency, the gain change of the first gain circuit 133 has less influence on the variation of the switching frequency parameter P4, and when the switching frequency parameter P4 is equal to or greater than the resonant frequency, the gain change of the first gain circuit 133 has greater influence on the variation of the switching frequency parameter P4. To avoid over-compensation, the first gain value can be greater than the second gain value.

In the present embodiment, the resonant frequency is:

$$\frac{1}{2 π √ LC}$$

wherein L is the inductance value of the first inductor Lr and C is the capacitance value of the resonant capacitor Cr.

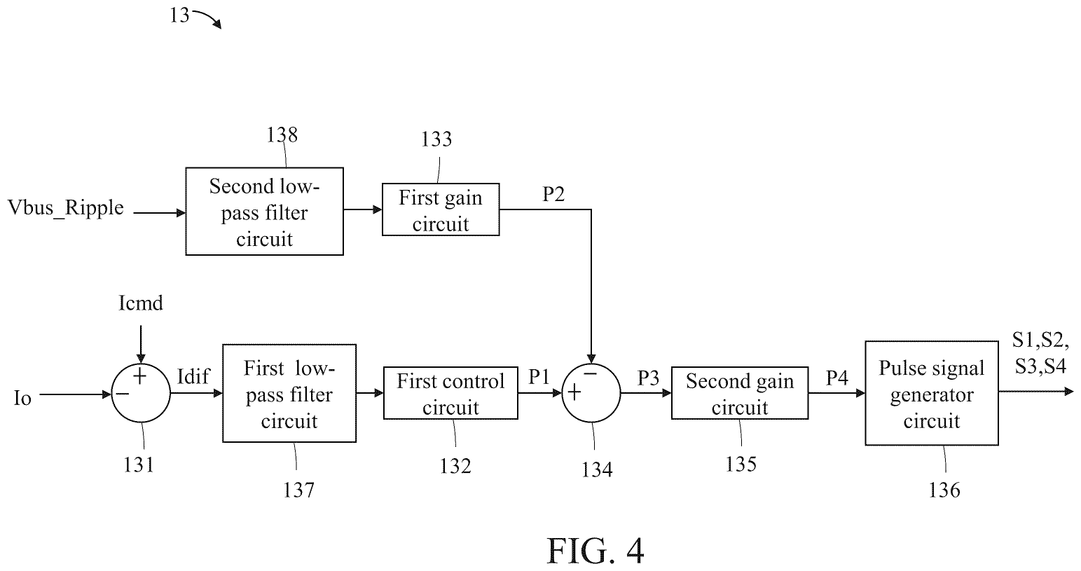

Refer to FIG. 4. To further improve the control accuracy of the controller 13, the controller 13 can further include a first low-pass filter circuit 137 and a second low-pass filter circuit 138 in the present embodiment. The first low-pass filter circuit 137 is coupled to the first subtraction circuit 131 and the first control circuit 132, and the second low-pass filter circuit 138 may be coupled to the power factor correction circuit 11 and the first gain circuit 133. The first low-pass filter circuit 137 filters out high-frequency noise from the current difference Idif, and the second low-pass filter circuit 138 filters out high-frequency noise from the ripple voltage Vbus_Ripple.

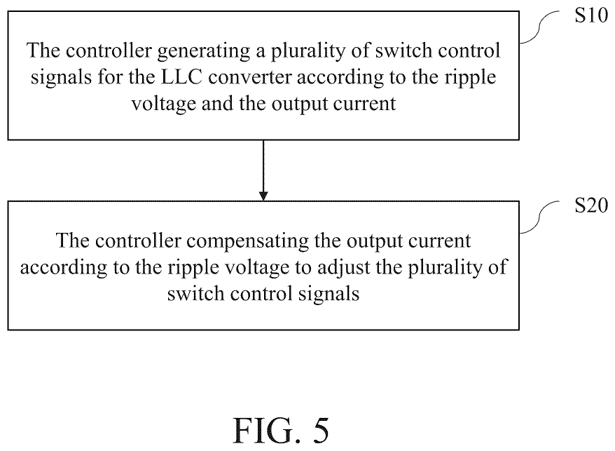

Refer to FIG. 5. Based on the aforementioned embodiments, the present application can be further summarized as a control method for the power supply converter device, which includes the LLC converter 12 coupled to the power factor correction circuit 11, and the controller 13 coupled to the power factor correction circuit 11 and the LLC converter 12. The power factor correction circuit 11 outputs the direct voltage Vbus and the ripple voltage Vbus_Ripple associated with the direct voltage Vbus, and the LLC converter 12 receives the direct voltage Vbus and outputs the output current Io. The control method includes the following steps:

Step S10: the controller 13 receiving the ripple voltage Vbus_Ripple and the output current Io and generating the plurality of switch control signals S1, S2, S3, and S4 for the LLC converter 12 according to the ripple voltage Vbus_Ripple and the output current Io;

Step S20: the controller 13 compensating the output current Io according to the ripple voltage Vbus_Ripple to adjust the plurality of switch control signals S1, S2, S3, and S4.

Through the aforementioned steps, the controller 13 compensates the output current Io according to the ripple voltage Vbus_Ripple from the power factor correction circuit 11 to adjust the plurality of switch control signals S1, S2, S3, and S4 for the LLC converter 12, thereby improving the control accuracy of the controller and the stability of the output of the LLC converter's output.

In the present embodiment, the controller 13 further includes a first subtraction circuit 131, a first control circuit 132, a first gain circuit 133, a second subtraction circuit 134, a second gain circuit 135, and a pulse signal generator circuit 136. In the present embodiment, the control method for the power conversion device further includes the following steps:
The first subtraction circuit 131 receiving the output current Io and the target current Icmd and calculating the current difference Idif between the output current Io and the target current Icmd;
The first control circuit 132 generating a first adjustment parameter P1 according to the current difference Idif;
The first gain circuit 133 receiving the ripple voltage Vbus_Ripple and generating a second adjustment parameter P2 according to the ripple voltage Vbus_Ripple;
The second subtraction circuit 134 subtracting the second adjustment parameter P1 from the first adjustment parameter P2 to compensate and generating a third adjustment parameter P3;
The second gain circuit 135 generating a switching frequency parameter P4 according to the third adjustment parameter P3; and
The pulse signal generator circuit 136 generating the plurality of switch control signals S1, S2, S3, and S4 for the LLC converter 12 according to the switching frequency parameter P4.

In the present embodiment, the control method for the power conversion device can further include the following steps: the controller 13 adjusting the gain value of the first gain circuit 133 according to the switching frequency parameter P4 and the first gain circuit 133 multiplying the next ripple voltage Vbus_Ripple by the adjusted gain value to generate the next second adjustment parameter P2.

In the present embodiment, the control method for the power conversion device can further include the following steps: when the controller 13 determines that the switching frequency parameter P4 is lower than the resonant frequency, the controller 13 adjusts the gain value of the first gain circuit 133 to a first gain value, and when the controller 13 determines that the switching frequency parameter P4 is equal to or greater than the resonant frequency, the controller 13 adjusts the gain value of the first gain circuit 133 to a second gain value, wherein the first gain value is greater than the second gain value. The switching frequency parameter P4 corresponds to the switching frequency of the plurality of switch control signals S1, S2, S3, and S4. When the switching frequency parameter P4 is lower than the resonant frequency, the gain change of the first gain circuit 133 has less influence on the variation of the switching frequency parameter P4, and when the switching frequency parameter P4 is equal to or greater than the resonant frequency, the gain change of the first gain circuit 133 has greater influence on the variation of the switching frequency parameter P4. To avoid over-compensation, the first gain value can be greater than the second gain value.

It should be noted that in this document, the terms “include” and “comprise,” and any variations thereof, are intended to cover a non-exclusive inclusion, so that a process, method, article, or apparatus that comprises a list of elements not only includes those elements but may also include other elements not expressly listed or inherent to such process, method, article, or apparatus. Without further limitations, elements defined by the phrase “comprising a . . . ” do not exclude the presence of additional identical elements in the process, method, article, or apparatus that comprises the element.

It should be noted that the embodiments given above are examples of the present application rather than limitations of the present application. Any variation without departing from the fundamental structure of the application is to be encompassed within the scope of protection in accordance with the broadest interpretation of the appended claims.

What is claimed is:

1. A power conversion device, comprising:
a power factor correction circuit configured to output a direct-current voltage and a ripple voltage associated with the direct-current voltage;
an LLC converter coupled to the power factor correction circuit and receiving the direct-current voltage to output an output current; and
a controller coupled to the power factor correction circuit and the LLC converter and receiving the ripple voltage, the controller configured to generate a plurality of switch control signals for the LLC converter according to the ripple voltage and the output current;
wherein the controller compensates the output current according to the ripple voltage to adjust the plurality of switch control signals.

2. The power conversion device as claimed in claim 1, further comprising a current sensing circuit coupled to the LLC converter and the controller, sensing the output current and sending the sensed output current to the controller.

3. The power conversion device as claimed in claim 1, wherein the controller further comprises:
a first subtraction circuit configured to calculate a current difference between the output current and a target current;
a first control circuit coupled to the first subtraction circuit and configured to generate a first adjustment parameter according to the current difference;
a first gain circuit configured to generate a second adjustment parameter according to the ripple voltage;
a second subtraction circuit coupled to the first control circuit and the first gain circuit and configured to subtract the second adjustment parameter from the first adjustment parameter and generate a third adjustment parameter;
a second gain circuit coupled to the second subtraction circuit and configured to generate a switching frequency parameter according to the third adjustment parameter; and
a pulse signal generator circuit coupled to the second gain circuit and the LLC converter and configured to generate the plurality of switch control signals for the LLC converter according to the switching frequency parameter.

4. The power conversion device as claimed in claim 3, wherein the controller is further configured to adjust a gain value of the first gain circuit according to the switching frequency parameter, and the first gain circuit multiplies a next ripple voltage by the adjusted gain value to generate a next second adjustment parameter.

5. The power conversion device as claimed in claim 4, wherein when the controller determines that the switching frequency parameter is less than a resonant frequency, the controller adjusts the gain value of the first gain circuit to a first gain value; and
when the controller determines that the switching frequency parameter is equal to or greater than the resonant frequency, the controller adjusts the gain value of the first gain circuit to a second gain value;
wherein the first gain value is greater than the second gain value.

6. The power conversion device as claimed in claim 3, wherein the controller further comprises:
a first low-pass filter circuit coupled to the first subtraction circuit and the first control circuit; and
a second-low pass filter circuit coupled to the power factor correction circuit and the first gain circuit.

7. The power conversion device as claimed in claim 1, wherein the LLC converter comprises:
a switching circuit coupled to the controller for receiving the direct-current voltage and the plurality of switch control signals;
a resonant circuit coupled to the switching circuit;
a transformer having a first side and a second side, the first side of the transformer is coupled to the resonant circuit; and
a rectifier circuit coupled to the second side of the transformer to output the output current.

8. A control method for a power conversion device, wherein the power conversion device comprises a power factor correction circuit, an LLC converter, and a controller; the LLC converter is coupled to the power factor correction circuit, and the controller is coupled to the power factor correction circuit and the LLC converter; the power factor correction circuit outputs a direct-current voltage and a ripple voltage associated with the direct-current voltage, the LLC converter receives the direct-current voltage to output an output current, the controller receives the ripple voltage from the power factor correction circuit, the control method comprising the following steps:
the controller generating a plurality of switch control signals for the LLC converter according to the ripple voltage and the output current; and
the controller compensating the output current according to the ripple voltage to adjust the plurality of switch control signals.

9. The control method for the power conversion device as claimed in claim 8, wherein the controller further comprises a first subtraction circuit, a first control circuit, a first gain circuit, a second subtraction circuit, a second gain circuit, and a pulse signal generator circuit;
the first control circuit is coupled to the first subtraction circuit, the second subtraction circuit is coupled to the first control circuit and the first gain circuit, the second gain circuit is coupled to the second subtraction circuit, and the pulse signal generator circuit is coupled to the second gain circuit and the LLC converter, the control method further comprising the following steps:
the first subtraction circuit calculating a current difference between the output current and a target current;
the first control circuit generating a first adjustment parameter according to the current difference;
the first gain circuit generating a second adjustment parameter according to the ripple voltage;
the second subtraction circuit subtracting the second adjustment parameter from the first adjustment parameter to generate a third adjustment parameter;
the second gain circuit generating a switching frequency parameter according to the third adjustment parameter; and
the pulse signal generator circuit generating the plurality of switch control signals for the LLC converter according to the switching frequency parameter.

10. The control method for the power conversion device as claimed in claim 9, the control method further comprising the following steps:
the controller adjusting the gain value of the first gain circuit according to the switching frequency parameter; and
the first gain circuit multiplying a next ripple voltage by the adjusted gain value to generate a next second adjustment parameter.

11. The control method for the power conversion device as claimed in claim 10, the control method further comprising the following steps:
when the controller determines that the switching frequency parameter is less than a resonant frequency, adjusting the gain value of the first gain circuit to a first gain value; and
when the controller determines that the switching frequency parameter is equal to or greater than the resonant frequency, adjusting the gain value of the first gain circuit to a second gain value;
wherein the first gain value is greater than the second gain value.
